(19) United States
(12) Patent Application Publication
(10) Pub. No.: US 2015/0042780 A1
(43) Pub. Date: Feb. 12, 2015

(54) 4F-BASED OPTICAL PHASE IMAGING SYSTEM

(71) Applicant: DANMARKS TEKNISKE UNIVERSITET, Lyngby (DK)

(72) Inventors: Darwin Z. Palima, Soborg (DK); Jesper Glückstad, Frederiksberg (DK)

(21) Appl. No.: 14/370,661

(22) PCT Filed: Jan. 7, 2013
(86) PCT No.: PCT/DK2013/050003

§ 371 Date: Jul. 3, 2014

Related U.S. Application Data
(60) Provisional application No. 61/583,804, filed on Jan. 6, 2012.

(30) Foreign Application Priority Data
Jan. 6, 2012 (EP) 12150382.5

(51) Int. Cl. G02B 27/52; G02B 21/14; G02B 26/06

(52) U.S. Cl. CPC G02B 27/52; G02B 26/06; G02B 21/14
USPC 348/79

(57) ABSTRACT

The invention relates to 4F-based optical phase imaging system and in particular to reconstructing quantitative phase information of an object when using such systems. The invention applies a two-dimensional, complex spatial light modulator (SLM) to impress a complex spatial synthesized modulation in addition to the complex spatial modulation impressed by the object. This SLM is arranged so that the synthesized modulation is superimposed with the object modulation and is thus placed at an input plane to the phase imaging system. By evaluating output images from the phase imaging system, the synthesized modulation is selected to optimize parameters in the output image which improves the reconstruction of qualitative and quantitative object phase information from the resulting output images.

### FIELD OF THE INVENTION

The invention relates to 4F-based optical phase imaging system and in particular to reconstructing quantitative phase information of an object when using such systems.

### BACKGROUND OF THE INVENTION

### Phase Ambiguity

Phase Contrast (PC) microscopy is extensively used in biology since many biological samples are almost transparent, and thus hard to see even in a microscope. By observing changes in phase rather than intensity, samples can be depicted with higher image quality.

While PC microscopy is sensitive to minute optical path changes in the cell the information retrieved is qualitative, i.e., it does not provide the actual phase delay through the sample. One issue in interferometric phase imaging is that different phases can have the same intensity in the resulting interference pattern. For example, +p/2 and −p/2 phase beams have the same intensity when interfering with a 0-phase reference beam. These phase ambiguities may be resolved in conventional interferometry by taking the interference pattern at different phase shifts of the reference beam. In GPC, a similar approach has been used by taking the GPC output for different phase shifts in the contrast filter, see P. J. Rodrigo, D. Palima, and J. Glückstad, “Accurate quantitative phase imaging using generalized phase contrast,” Opt. Express 16, 2740-2751 (2008), so that differences larger than lambda/10 in the optical path length between parts of the sample can be made clearly visible.

Phase contrast microscopy and GPC typically applies 4F optical systems in the form of common path interferometers using a phase contrast filter (PCF) to synthesize a phase-shifted reference beam (the synthetic reference wave, SRW). The interference of the SRW with the input phase image at the output plane creates high-contrast intensity distributions.

Typically, PC microscopes are provided with different objectives, each involving a PCF with a filtering function selected to provide adequate filtering over a relatively narrow range of object phase modulations. This works well for so-called “weak phase” objects, but can lead to wrong features and artefacts when studying objects that create stronger phase modulation. In GPC, one achieves optimal phase contrast over a wider range of object phase modulations using different filtering functions, see J. Glückstad and P. C. Mogensen, “Optimal phase contrast in common-path interferometry,” Appl. Opt. 40, 268-282 (2001). While these methods are sufficient for visualizing weak phase objects, they do not provide the desired results for larger phase strokes and for quantitative phase imaging.

Common-path interferometer uses the low-frequency components of the input phase modulation to create the reference wave for making the phase patterns visible. However, the unpredictability of unknown object phase modulations means that the imaged phase object may not have enough low-frequency components, since the synthesized reference wave would then be too weak and so would generate interference patterns having poor contrast. For example, A perfectly symmetric phase pattern would not contain any zero-order component since light from the pi-out-of-phase regions would cancel each other on-axis. In other words, when imaging unknown objects one cannot be sure that the frequency components in the Fourier transform of the imaged phase object are suitable for the filtering function of the PCF.

A number of documents relates to improving output images of 4F optical imaging systems.

US 2009/0290156 relates to rendering quantitative phase maps across and through transparent samples. A broadband source is employed in conjunction with an objective, Fourier optics, and a programmable 2D phase modulator at the filter plane to obtain amplitude and phase information in an image plane. The programmable 2D phase modulator can be programmed so that it provides phase rings suitable for the frequency components in the Fourier transform of the object phase modulation, see e.g. [0091]-[0096] and FIGS. 6a-c.

It is a disadvantage that even though the phase ring can be programmed to induce different phase shifts and amplitude modulations, it still only modifies the frequency components within the ring. When imaging unknown object phase modulations, the frequency components within this ring may be distorted or too weak, thereby resulting in a poor contrast in the output. Faced with this disadvantage, the SLM could be programmed to display different masks, as mentioned in [0092] of US 2009/0290156, such as to select suitable frequency components for the reference beam.

Opt. Express 19821, vol. 16, No. 24, 24 Nov. 2008, relates to the use of two SLMs: one SLM creates the frequency filter, e.g., a phase ring or a random array of phase dots, while another SLM is encoded with a fixed hologram which has been precisely calibrated to create a ring or dot array in the filter plane to match the filter pattern. The random dot array can minimize some unwanted artefacts present when using a ring filter. However, when imaging unknown arbitrary object phase modulations, the frequency components within the dots may be distorted or too weak, thereby resulting in a poor contrast in the output.

Opt. Exp. 14063, Vol. 18, No. 13, 21 Jun. 2010, relates to quantitative differential interference contrast (DIC) microscopy and provides all-electronic acquisition of multiple phase shifted DIC-images at video rates which can be analysed to yield the optical path length variation of the sample. It shows (Abstract, FIG. 1) the use of a SLM as a flexible Fourier filter in differential interference contrast (DIC) microscopy.

EP 0840159 A1 describes an image forming apparatus for displaying a target image, the apparatus comprising a 4F setup. An image is formed on the input plane of the 4F setup by use of a liquid-crystal display (LCD) panel, imaged onto a Parallel Aligned Liquid-crystal SLM (PALSLM). The reference discloses optimizing parameters of the LCD panel, the PALSLM and the PCF to ensure that the image output from the 4F setup matches the target image. Thus, the reference concerns image formation of a known image.

### SUMMARY OF THE INVENTION

It is an object of the invention to improve image quality in phase imaging systems based on 4F optical imaging systems. For this purpose, the invention provides a method, a computer program product, and an imaging system.

When imaging an object in a 4F optical imaging system in the prior art, the spatial amplitude and phase modulation impressed by the object to be imaged will, together with the aperture function of the light illuminating the object, determine the frequency components in the Fourier transform. The interaction between the frequency components and the PCF determines the SRW which through interference with the object phase modulation forms an intensity image at the output plane. Thus, the qualitative and quantitative parameters in the output image are largely determined by the object modulation which is typically unknown. As an example, a poor match between the frequency components in the Fourier transform of the object phase modulation and the filtering function of the PCF can result in an output image with poor contrast. This means that in case of a poor output image, the 4F setup must be modified to be more suitable for the object to be imaged

In US 2009/0290156, the phase shift of the PCF is varied in order to perform a quantitative phase imaging of the object.

The invention involves a new approach that combines well-known 4F optical imaging systems with a complex SLM for adding an adjustable complex spatial modulation (hereafter the synthesized modulation) which is superimposed with the object modulation to form a merged modulation that is imaged (referred to hereafter as the merged modulation). Controlling the synthesized modulation means controlling the input merged modulation and thereby the frequency components in the Fourier transform and ultimately the SRW can be controlled. Thus, instead of modifying the 4F setup to match the input modulation as determined by the object, the input modulation is modified to match the performance of the 4F setup.

In a first aspect, the invention provides a method for reconstructing a quantitative phase image of an object using a 4F-based optical phase imaging system in accordance with claim 1.

In a second aspect, the invention provides a computer program product for reconstructing a quantitative phase image of an object imaged by a 4F-based optical phase imaging system in accordance with claim 15.

In a third aspect, the invention provides a 4F-based optical phase imaging system for reconstructing a quantitative phase image of an object in accordance with claim 16.

By adjusting the synthesized modulation, the frequency components in the Fourier transform of the merged modulation can be controlled to match the PCF so that it can work optimally and/or as intended. This ensures that a SRW providing high contrast output image can be generated with the same PCF for almost any object. The invention thereby resolves the above-mentioned problems related to the reference beam resulting from a mismatch between the PCF filtering function and the frequency components in the Fourier transform of the object phase modulation.

The method for reconstructing the phase image is generally performed during operation of the phase imaging system, i.e. during examination of the object. As such, any calibration steps needed may be performed prior to steps of the inventive method.

The solution of the present invention provides the advantage that an optimal GPC imaging of unknown object phase modulations can be achieved fast, since the adjustment of the synthesized modulation can be performed by a computer and since no exchange of PCF is required. It is another advantage that the modification to suit the PCF can be performed for a very broad range of object phase modulations, thereby rendering a wide selection range of different PCFs superfluous. This provides the further advantage that the invention incurs little extra costs, since relatively cheap SLMs can be applied and since the wide selection range of different PCFs are not required.

In a further aspect, the invention provides a method for reconstructing a quantitative phase image of an object using a 4F-based optical phase imaging system, the method comprising:
imaging an object using a 4F-based optical phase imaging system, involving impressing a complex spatial object modulation on an input to the phase imaging system;
evaluating an output image of the phase imaging system;
based on the output image, selecting a complex spatial synthesized modulation adapted to optimize a selected parameter in the output image;
addressing a two-dimensional, complex spatial light modulator to impress the synthesized modulation, the spatial light modulator being arranged so that the synthesized modulation is superimposed with the object modulation to form a merged modulation impressed on the input to the phase imaging system;
imaging the merged modulation using the phase imaging system; and
reconstructing a quantitative phase image of the object based on the synthesized modulation and an output image of the merged modulation.

A complex spatial modulation can generally be expressed as a(x, y) e^{iφ(x,y)} or simply a e^{1φ} where the spatial dependency is implicit. It is understood that in cases where a(x, y) is constant it is a phase-only modulation and where φ(x, y) is constant it is an amplitude-only modulation. The term complex is thus not meant to indicate that the modulation will involve both amplitude and phase parts in all cases, but that it can hold both. Using this notation:
the complex spatial modulation impressed by the object is designated aₒ e^{iφ}^{₀} and generally referred to as the object modulation;
the complex spatial modulation impressed by the SLM and superimposed on the object modulation is designated aₛ e^{iφ}^{ₛ} and generally referred to as the synthesized modulation;
the complex spatial modulation resulting from superimposing the synthesized modulation with the object modulation is designated a_{M} e^{iφ}^{_{M}}=aₒ·aₛ e^{i(φ}^{ₒ}^{+φ}^{ₛ₎} and generally referred to as the merged modulation;
the spatial complex modulation which is effectively input to the 4F optical imaging system is a result of residual modulation from the illumination of the object (e.g. an aperture or annulus), the object modulation, and any synthesized modulation is designated a_{I} e^{iφ}^{_{I}} and generally referred to as the imaged modulation;
The output intensity distribution from an imaging process using the 4F optical imaging system is designated I(x, y) and generally referred to as the output image.

A 4F optical system is a system involving a 4F setup as known from the field of Fourier optics and also referred to as a 4F arrangement. A typical 4F setup 1 is shown in FIG. 1 and involves two lenses 3, 5 and a transmission mask 4 arranged in their focal planes so that there are 4 focal lengths between the input- or object plane 2 and the output- or imaging plane 6. It is noted that lens 5 may potentially be omitted and imaging be performed in a far-field observation, which theoretically corresponds to moving the imaging plane 6 to infinite. As this works equivalent to the setup shown in FIG. 1, such setup is also referred to as a 4F setup. The plane of the transmission mask 4 is commonly referred to as the filter- or Fourier-plane. The transmission mask 4, commonly also referred to as the 4F correlator, performs the convolution between the input image as Fourier transformed by the first lens and the mask function encoded into the mask. The transmission mask is typically an amplitude and phase modulator or filter, wherein the mask- or filter function is manifested by areas that blocks or damps transmission and/or phase shifts the incoming light.

In one embodiment of the inventive method, the 4F optical system is or is comprised by a microscope, or is in optical communication with an optical path of a microscope. In this way, the method may e.g. be used to remedy phase ambiguity issues in a PC microscope. The 4F optical system may be included directly in the microscope, or may be provided as an add-on module to upgrade existing microscopes. Such a module may e.g. be attached to an output port, such as a camera port of the microscope.

A complex SLM is any SLM capable of impressing both amplitude and phase modulation on light impinging thereon. Traditional amplitude-only modulators maybe used to effectively impress a phase modulation if e.g. a diffractive structure is written. Similarly, traditional phase-only modulators maybe used to effectively impress an amplitude modulation if e.g. a diffractive structure is created, an interference pattern is created or light is scattered outside the finite apertures of the optical system.

That the SLM is addressable means that the synthesized modulation impressed by the SLM can be dynamically controlled, i.e. introduced, adjusted, and removed by addressing the SLM electronically, preferably via a computer. The modulation to be impressed is preferably determined electronically, such as on a computer, as an array of aₛ and φₛ values.

The selected parameter is a parameter that, with regard to the objective of the phase quantification and the type of object, is used to steer or guide the process of selecting the synthesized modulation. The selected parameter is a qualitative and/or quantitative parameter, quality, or characteristic detectable in or derivable from the output image. The selected parameter may be a measure of performance or a figure of merit of the output image and/or the phase imaging system. Optimizing the selected parameter in the output image thus refers to selecting the synthesized modulation so that the selected parameter in the following output image of the merged modulation is changed towards a desired criteria, goal or objective. For example, if the selected parameter is contrast, the desired criteria is a contrast which higher than before or as high as possible; if the selected parameter is cancellation of the object modulation, the desired criteria is an output image equal to an output image without any object or synthesized modulation.

In the following, a number of further aspects, preferred and/or optional features, elements, examples and implementations will be described. Features or elements described in relation to one embodiment or aspect may be combined with or applied to the other embodiments or aspects where applicable. For example, structural and functional features applied in relation to the imaging system may also be used as features in relation to the method for phase imaging by proper adaptation and vice versa. Also, explanations of underlying mechanisms of the invention as realized by the inventor are presented for explanatory purposes, and should not be used in ex post facto analysis for deducing the invention.

In preferred embodiments, the 4F optical imaging system is a phase contrast imaging system or a wavefront sensing system comprising a common-path interferometer used to image a spatial phase distribution at the input plane as an intensity distribution at the output plane. Preferably, the 4F optical imaging system is a GPC system. In these setups, the transmission mask is typically a phase contrast filter (PCF), which transmits the input phase distribution and generates a phase shifted reference beam, so that the input spatial phase distribution is converted to a spatial intensity distribution at the image plane. In such systems, the invention provides control of the SRW leading to an improved phase contrast image quality.

In a further embodiment, the adjustment of the synthesized phase modulation is dynamically adjusted during an image recording sequence so as to enable deriving quantitative information from the output images. This provides the advantage of resolving the above-mentioned limitations and problems related to phase ambiguity and/or poor reference beam.

In preferred embodiments, the selected parameter in the output image comprises one or more of: resolution, contrast, phase quantification, phase range, a relation (such as a mapping) between input phase values and output intensity values, cancellation of object modulation by synthesized modulation. These will be further described and exemplified by embodiments in the following schemes.

The selected parameter in the output image may comprise contrast, which is generally related to the strength of the SRW. In this scheme, the synthesized modulation may be selected to disturb a balance between parts of the object phase modulation that would otherwise at least partly cancel out and result in a weak synthetic reference wave, which would again result in poor contrast in the output image. Such balanced parts may e.g. be equally abundant pi-out-of phase parts, or more unequal parts at non-pi-out-of-phase that partly cancels out each other—this cancelling out can be visualized by imagining vector addition. With this selected parameter, the objective is to strengthen the SRW and obtain a higher contrast in the output image. This may be achieved by introducing an imbalanced synthesized modulation for these parts, so that pronounced destructive interference between the effective phase modulation and the SRW can be avoided.

Aside from few contrived objects, perfect cancelation is rare, so there is usually a poor output image to start with to guide the selection process of the synthesized modulation. Also, in practice, aside from pure curiosity experiments, one would not be dealing with completely unknown objects and so one typically has an idea what to look for, and it is thus a matter of improving detection of these features. In cases where complete cancellation occurs, the first step is to methodically disturb the balance through series of predefined/contrived additional phases, such as stripes, checkerboards, concentric rings, or grid, etc. In cases where a poor output image already exists, the first step is to purposely, and by design, disturb the balance to create an SRW that better matches the PCF. In a preferred embodiment, a first step is to select a synthesized modulation that is derived from the output image, so that parts with similar or equal intensity in the out image will be modulated equally; and differently from parts with dissimilar intensities.

Selecting a synthesized modulation according to this criterion provides the advantage of improving the contrast in the output image of the merged modulation.

The selected parameter in the output image may comprise phase quantification with the objective of resolving phase ambiguities between parts in the object modulation with equal but opposite phase shifts. This may be achieved by introducing a phase-offset resulting in these parts having non-equal phase shifts. Under this criterion, a synthesized phase modulation can be selected which provides a phase-offset for parts having similar intensity values in the output image.

Selecting a synthesized modulation according to this criterion provides the advantage of resolving potential phase ambiguities in the output image of the object modulation. The prior art solutions are disadvantageous in that they require recordings using different PCFs. It is an advantage of the present invention that such ambiguities can be resolved using a fixed PCF.

The selected parameter in the output image may comprise cancellation of object modulation by synthesized modulation. In this scheme, the objective is to encode the synthesized phase modulation to be the negative of the object phase modulation, i.e. so that the two cancels each other. This is referred to as the negative object approach. In this scheme, the synthesized modulation is preferably selected to, based on the output image (of the object or merged modulation) and a known or anticipated relation between input phase modulation and output intensity values, cancel the object phase modulation, i.e. selecting a synthesized modulation which is equivalent to the negative object phase modulation.

This will produce an output image of a flat phase front, something which in GPC is typically associated with a central bump shown in FIG. 6, which indicates that the aperture size results in an out-of-phase SRW that is twice as strong as the aperture illumination on-axis. Thus, the selection of the synthesized modulation preferably also involves knowledge of the output image of the phase imaging system without object modulation and synthesized modulation.

Arriving at a synthesized modulation equal to the negative object phase modulation is preferably based on an iterative feedback mechanism, such as a proportional-integral-differential (PID) controller. Eventually, a successful cancellation provides a useful verification that the obtained synthesized phase modulation corresponds to the object phase modulation (assuming illumination with a flat wavefront) as shown in FIG. 9. With the negative object approach, it is not the object phase modulation or a characteristic thereof which is sought optimized in the output image. Rather, in this case, a selected parameter may be to reducing the overall contrast in the output image or obtaining the expected output image from a flat phase front.

The selected parameter in the output image may comprise a relation between input phase values and output intensity values. Such relation is helpful when correlating output intensity values with input phase values to approximate the merged modulation and therefrom calculate the object modulation. It is preferred that the synthesized modulation is selected to calibrate this relation. This may involve identifying a section in the output image of the object with no object modulation (i.e. a section that has the same intensity value as an image with no object), set a known synthesized phase value for this section, and observe the resulting change in intensity value for this section. Preferably, such calibration may be performed using several different synthesized phase values in several different sections in the output image of the object with no object modulation. This provides the advantage of calibrating the mapping between intensity values and input phase values and thereby allow for phase quantification. This will be described in greater detail later with reference to FIGS. 8A-G.

Alternatively or additionally, the calibration of this relation may involve selecting the synthesized modulation to increase the range of intensity values in the output image, e.g. adjusting so the that the lowest intensity values become equal to zero (black) and increasing the largest intensity values (i.e. as many photons as possible). This calibration provides the advantage optimising the resolution in the mapping between intensity values and input phase values.

The selected parameter in the output image may comprise a relation between input phase values and output intensity values and wherein the synthesized modulation is selected to form a bijection between input phase values and output intensity values. A bijection means that each intensity value corresponds to exactly one phase value, so that the mapping between intensity values and input phase values is a one-to-one correspondence. This may be achieved by using a combination of the embodiments for resolving phase ambiguities and calibrating the relation between input phase values and output intensity values described previously.

The selected parameter in the output image may comprise spatial resolution of the phase image and wherein the synthesized modulation is selected to project phase fringes to redirect light from the fine details having higher spatial frequencies, which would otherwise be deflected at large angles and so not be captured by the imaging system. In this case the synthesized modulation deflects these otherwise lost light, and so lost details about the object, back to the input to the phase imaging system so that they can be detected at the output.

It may be preferred that the synthesized modulation is selected to optimise the selected parameter within a selected phase range. This will be described in greater detail later with reference to FIGS. 6A-D. This may be advantageous in order to accommodate the limited operation ranges of existing phase imaging systems. This is similar to the cancellation of object modulation by synthesized modulation but, in this case, we only partially, and up to scale, cancel the object phase modulation so as to get a merged modulation that is within a narrower operating range of the phase imaging system used. This enables one to use conventional phase imaging system to visualize objects having wider phase ranges. In one embodiment, one can first implement a cancellation procedure and, after finding the cancelling phase modulation, subsequently use a scaled/reduced version to partially cancel the object phase while preserving its structural features so that the reduced/rescaled merged phase visualizes these features using a limited-range system.

The selection of the synthesized modulation is typically a result of the evaluation of the output image of the object modulation. If this is a true, unambiguous and quantifiable representation of the object phase modulation, there is no need to also impress the synthetic modulation. In other cases, a selected parameter in the image may be improved according to the invention to obtain the information in such true representations. In such cases, the selection of the synthesized modulation may be derived from the output image of the object modulation or it may be a default modulation which from experience resolves frequently occurring problems encountered and which are easy to deconvolute. This will be described in greater detail later with reference to FIGS. 7A-D.

Synthesized modulations may be derived from the output image of the object modulation by deriving the synthesized modulation as a function of the output image of the object modulation, aₛ(x, y)=f[Iₒ(x, y)]. Some examples of synthesized modulation include: simple offset and proportional to output image, aₛ(x, y)∝TH[Iₒ(x, y)]+constant; series expansion of the output image, aₛ(x, y)=a₀+a₁ Iₒ(x, y)]+a₂ Iₒ(x, y)²+ . . . ; trigonometric relation to the output image, e.g. aₛ(x, y)=m cos⁻¹{[I₀(x, y)−A (x, y)−B(x, y)]/n}+p, where the constants m, n, p and functions A(x, y) and B(x, y) are determined based on the theoretical model of the actual phase imaging system used (e.g. GPC) and may be iteratively adjusted; etc, or a combination of these functions. In preferred embodiments, the synthesized amplitude and/or phase modulation is proportional to a threshold function of the image of the object modulation so that: aₛ(x, y)∝TH[Iₒ(x, y)] and/or φₛ(x, y)∝TH[Iₒ(x, y)].

When it is impractical to derive the synthesized modulation from the output image (e.g., due to problems like too low contrast, etc), or when the user decides, the synthesized phase modulation can employ default modulations that are not derived from the output image. Examples of default modulations that are not derived from the output image of the object modulation but which resolves often encountered problems may be lines, phase stripes, checkerboards, concentric rings, grid, random dots, etc. These simple patterns would be easy to deconvolute once the output pattern has been improved. The improved image can then form the basis for deriving subsequent synthesized modulation.

The selection of the synthesized modulation preferably comprises iteratively adjusting the synthesized modulation. This is preferably implemented through a dynamic adjustment and/or optimization of the merged phase modulation (effectuated by adjustment of the synthesized modulation) based on a running observation of the generated output imaged. Such iterative or dynamic adjustment may be used to further improve the selected parameter related to quantitative phase imaging. According to this embodiment, selecting the synthesized modulation comprises iteratively performing the evaluation of the output image, the selection of the synthesized modulation, and the addressing of the spatial light modulator to impress the synthesized modulation before reconstructing the quantitative phase image of the object. Preferably, the evaluation of the output image at the first instance involves the output image of the object modulation only, whereas in later instances, it involves the output image of the latest merged modulation.

The dynamic adjustment and/or optimization of the synthesized modulation may comprise a feedback loop so that a new synthesized modulation is based on, derived from, or proportional to a threshold function of the output image of a previous merged modulation, e.g. aₛ(x, y)∝TH[I_{M}(x, y)] and/or φₛ(x, y)∝TH[I_{M}(x, y)].

The invention provides the further advantage that smaller regions of interest of the object may be defined by means of the synthesized modulation. This can be done by encoding additional phase modulation outside the regions of interest such that light from these regions get deflected beyond from the acceptance angle of the of the phase imaging system and not contribute to the imaging. Alternately, one may encode a cancellation phase in these regions, and then potentially an offset so as to get a merged phase that yields a black intensity level at the output. This alternative can reuse light from these dark regions and channel them to the regions of interest to improve brightness.

In one embodiment, the invention also provides control of the synthetic reference wave by proper selection of the synthesized modulation. This can be advantageous, e.g. when there are slowly varying phase gradients in the object background scene, which though not the subject of interest, can distort the SRW. The added modulation can also improve the SRW by cancelling the other uninteresting or known regions of the scene that would otherwise disturb the SRW.

An output image from the phase imaging system will be deteriorated by various sources of errors such as noise, approximations and imperfections in the optical system, inherent phase modulations in the illuminating light, finite resolution in the SLM etc. In one embodiment, the step of reconstructing the quantitative phase image of the object comprises determining an effective input modulation from the output image of the merged modulation and deconvoluting the effective input modulation with the synthesized modulation to recover the object modulation. Here, the effective input modulation is the best guess of the merged modulation which can be determined from the output image of the merged modulation, taking into consideration and compensating for known sources of error.

### BRIEF DESCRIPTION OF THE FIGURES

The invention will now be described in more detail with regard to the accompanying figures. The figures show one way of implementing the present invention and is not to be construed as being limiting to other possible embodiments falling within the scope of the attached claim set.

FIG. 1 illustrates a 4F setup.

FIGS. 2A and B show generalized setups of the 4F optical imaging system as applied in various embodiments of the invention.

FIGS. 3A and B are schematic illustrations of 4F optical imaging systems applying diffractive input modulation according to an embodiment of the invention.

FIGS. 4A-D shows for an example illustrating an embodiment of the invention: (4A) the output image of the object modulation; (4B) the output image of the merged modulation; (4C) the synthesized modulation; and (4D) line scans through the center of the images of FIGS. 4A (dotted) and 4B (solid).

FIGS. 5A-D shows for an example illustrating an embodiment of the invention: (5A) the object phase modulation; (5B) the output image of the object modulation; (5C) the synthesized modulation; and (5D) the output image of the merged modulation.

FIGS. 6-8 illustrates further embodiments and examples of some of the schemes for selecting a synthesized modulation to optimise the out image.

FIG. 9 shows a standard output image from a GPC imaging of a blank input.

### DETAILED DESCRIPTION OF THE INVENTION

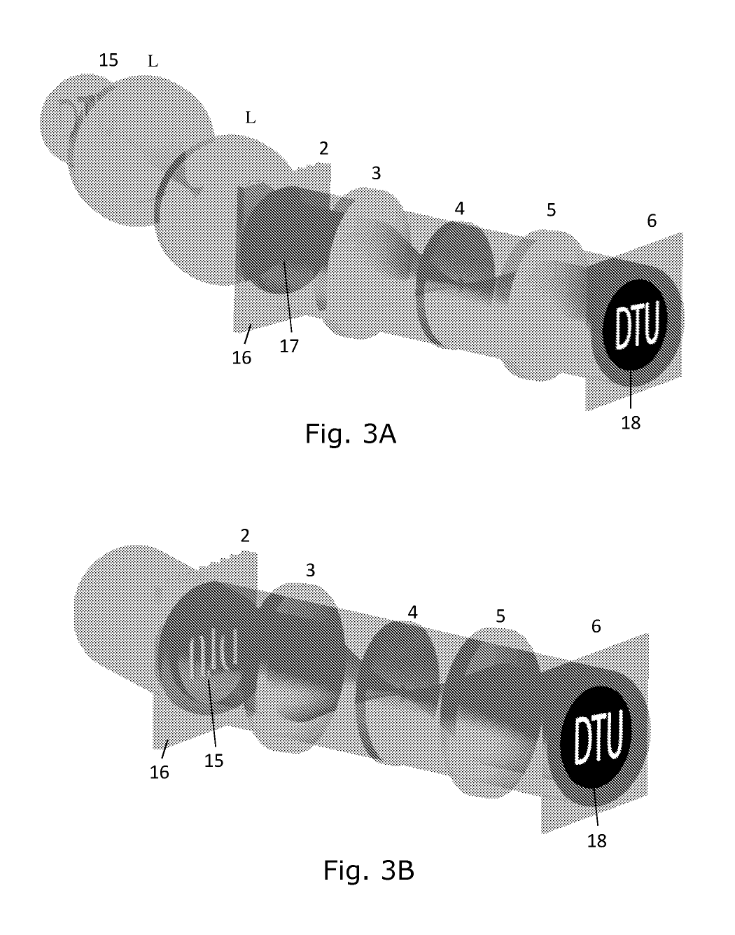

FIGS. 2A and B show generalized setups of the 4F optical imaging system 10 as applied in various embodiments of the invention.

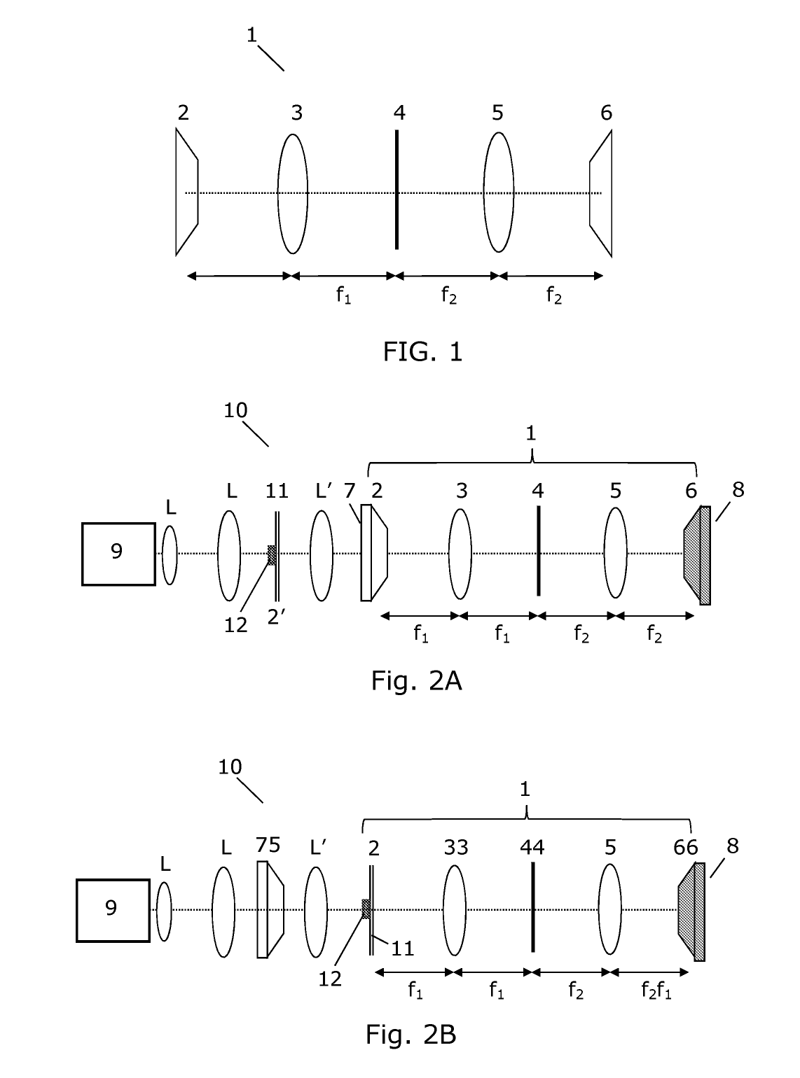

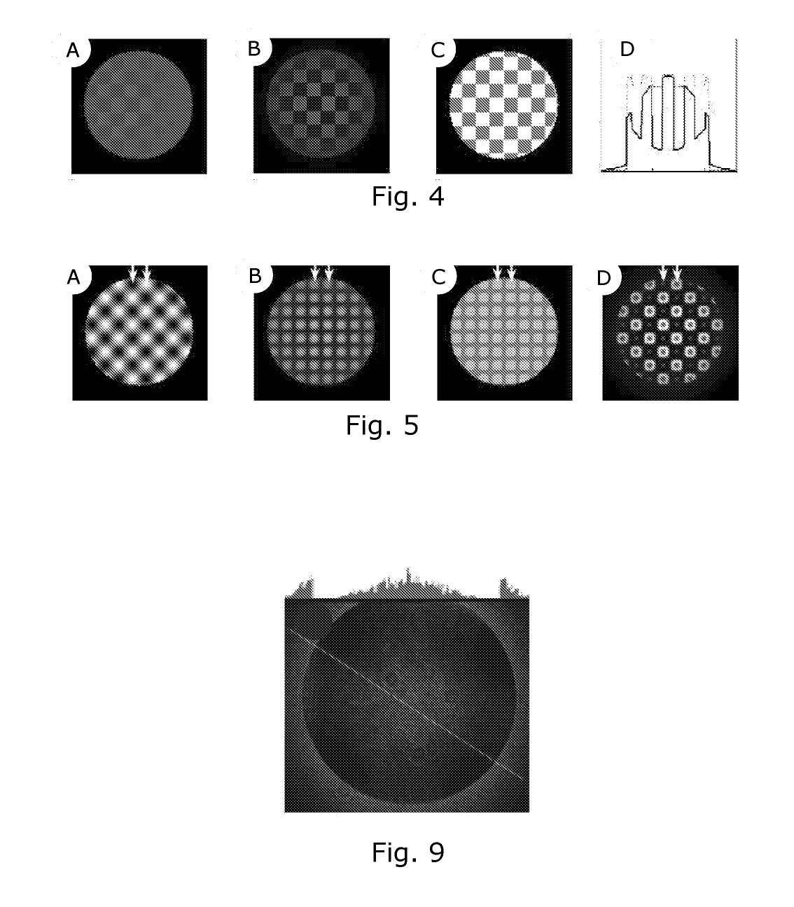

In FIG. 2A, the 4F optical system involves a 4F setup 1 as described earlier in relation to FIG. 1. In addition, it comprises a SLM 7 for impressing the synthesized modulation and an image detector 8 for detecting the output image at imaging plane 6. In preferred embodiments, the system may further comprise a light source 9 and an object or sample holder 11 for holding the object 12 in another object plane 2′. The image detector 8, the light source 9 and the object holder 11 may comprise additional optical elements such as lenses L. Especially lens L′ represents image relay optics that duplicates the light at the object plane, 11, with or without magnification, to the input plane 2. This L′ may consist of several lenses, e.g. there are two in FIG. 3A.

FIG. 2B illustrates the 4F optical system of FIG. 2A, but where the order of the object 12 and the SLM 7 is reversed. It is noted that the object modulation and the synthesized modulation are still superimposed and provided as input to the 4F optical system.

FIGS. 2A and B illustrate linear configurations of the 4F optical imaging system, however, numerous equivalent configurations such as folded configurations are possible as will be appreciated by the skilled person.

### Diffractive Grating SLM

The addressable, two-dimensional, complex spatial light modulator used in the invention may in principle be any SLM capable of impressing amplitude and/or phase modulations.

In a preferred embodiment, the SLM is implemented using diffractive modulation and is schematically depicted in FIGS. 3A and 3B. In these setups, the object modulation is superimposed with a phase-only diffractive optical element, such as a blazed grating or carrier frequency modulation, for example, acting as a carrier. This provides the advantage that a synthesized modulation involving both amplitude and/or phase can be impressed using the same element and with low-loss. The diffractive modulation also enables the use of binary phase devices for encoding more phase levels since different lateral shifts in the binary gratings translates different phase levels along a diffraction order.

FIGS. 3A and B show schematics of GPC systems with diffractive input modulation. In FIG. 3A, the phase object, 15, is relayed to a diffractive element, 16 at the GPC input plane 2, using lenses L. The diffractive element is used to impress the carrier modulation as well the synthesized modulation 17 according to the invention. The resulting modulation is used as GPC input. In FIG. 3B, the GPC input plane 2 contains both the phase object, 15, and the diffracting element, 16. In both systems, the resulting phase modulation along a diffraction order is imaged at the output plane, 6, and transformed into a high-contrast intensity pattern 18 via interference with a common-path reference wave synthesized by the phase contrast filter, 4.

In the corresponding examples described herein, the SLM is a phase-only SLM (Holoeye HOE 1080) which is used to encode both the exemplary object phase modulation and the diffracting element (the diffractive carrier and the synthesized modulation). The use of a dynamic diffractive optical element for encoding the synthesized modulation allows for on-the-fly optimization of the input aperture parameters (the imaged modulation) according to desired output characteristics as well as full freedom to impress synthetic amplitude and/or phase modulation in a simple way.

The following describes the formalism of using a dynamic diffractive optical element for encoding the synthesized modulation or the object and synthesized modulation (the merged modulation).

The conventional GPC input field is

p_{C}(x,y)=a(x,y)exp[iφ(x,y)], (1)

where the amplitude modulation, a(x,y), (e.g. an aperture function or Gaussian illumination) is coupled with a phase modulation, φ(x, y). The image of this input interferes with the synthesized reference wave at the output plane to form an intensity pattern,

I(x′,y′)≈|a(x′,y′)exp[iφ(x′,y′)]+rₛ(x′,y′)|² (2)

where the reference wave is a slowly varying function,

rₛ(x,y)= α̅[exp(iθ)−1]ℑ⁻¹{S(fₓ,f_{y})ℑ{a(x,y)}}, (3)

This expression incorporates the effect of the input phase into a complex amplitude factor,

α̅=∫∫a(x,y)exp[iφ(x,y)]dxdy/∫∫a(x,y)dxdy, (4)

which represents the normalized zero-order term of the input's Fourier transform. The present GPC approach uses diffractive input modulation and is schematically depicted in FIGS. 3A and B. This differs from the conventional setup in that the object phase modulation is now combined with a phase-only diffractive optical element, such as a blazed grating or carrier frequency modulation, for example. Under standard conditions, the GPC output will visualize this input phase, including the additional diffractive phase modulations. To render only the phase input, the optical setup can be reconfigured to match the diffractive phase modulation, as will be described shortly.

In the present approach, a diffractive phase modulation is added to the object phase modulation, which could be done in standalone configuration (FIG. 3A) or by field multiplication of a relayed object phase modulation to a diffracting plane (FIG. 3B). The modified input becomes

$$\begin{matrix}{p}_{M} ( x , y ) = a ( x , y ) exp [ i φ ( x , y ) ] exp [ i {φ}_{D} ( x , y ) ] \\ = a ( x , y ) exp \{ i [ φ ( x , y ) + {φ}_{D} ( x , y ) ] \} ,\end{matrix} \qquad ( 5 )$$

where φ_{D}(x, y) is the phase-only diffractive modulation. In standard GPC, this will simply cause the system to visualize the modified phase input, φ(x, y)+φ_{D}(x, y), instead of the original φ(x, y). By proper choice of the diffractive element and a corresponding adjustment of the optical system, it is possible to render an output intensity pattern that is based only on the phase φ(x, y).

As a simple starting point, consider a blazed grating as our additional phase-only diffractive element. The input in this case becomes

p_{M}(x,y)=p_{C}(x,y){[exp(2πif₀x)rect(x/2w)] [symbol] comb(x/X)}, (6)

where w is the width of each repeated segment of the grating; X is the grating period; f₀ is a constant related to the blaze angle; rect(x)=1 for |x|≦½ and zero otherwise; and comb(x)=Σ_{-∞}^{∞}δ(x−n). The field at the filter is directly proportional to Fourier transform

P_{M}(fₓ,f_{y})=P_{C}(fₓ,f_{y}) [symbol] {2wX sin c[2w(fₓ−f₀)]comb(Xfₓ)}. (7)

In the ideal case of a 100% fill factor (i.e., X=2w) and a blaze angle f₀=m/X, the comb aligns with the zeros of the sin c function except at the m^{th}-order where all of the energy goes:

P_{M}(fₓ,f_{y})=P_{C}(fₓ−m/X,f_{y})2wX sin c(m/X−f₀), (8)

Aligning the GPC axis along this diffraction order will cancel the frequency offset to reproduce the usual intensity pattern at the GPC output. For non-ideal blaze angles, the sin c term in Eq. (7) is less than 1 and light will be lost into spurious diffraction orders. However, this enables us to control the input amplitude by spatially modulating the blaze angle, which may be exploited to optimize desired output metrics.

### Selecting the Synthesized Modulation

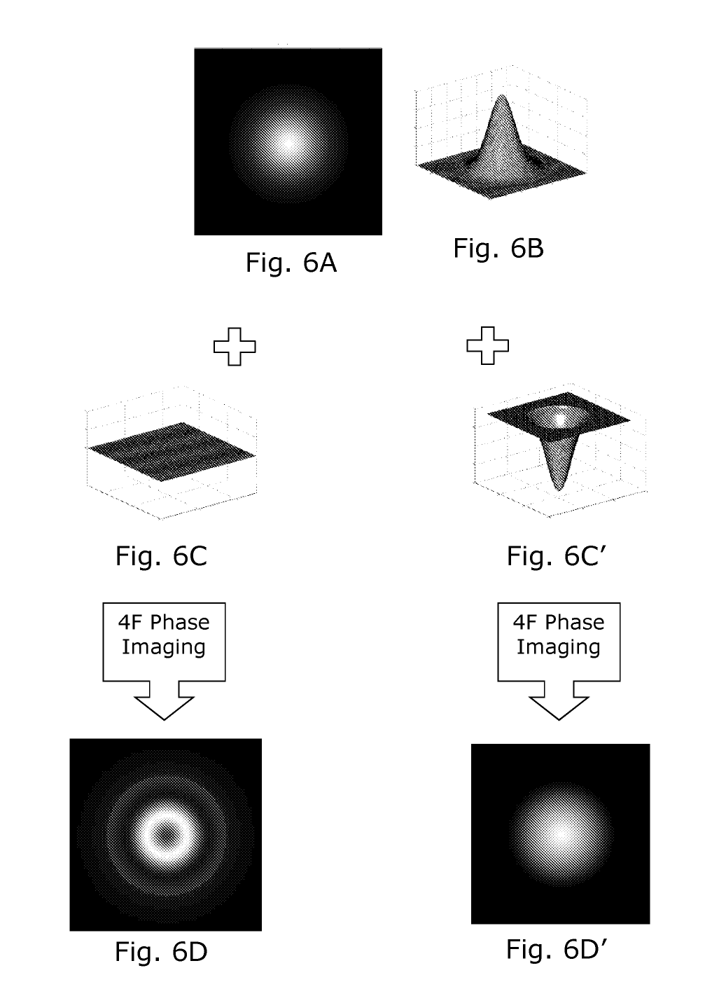

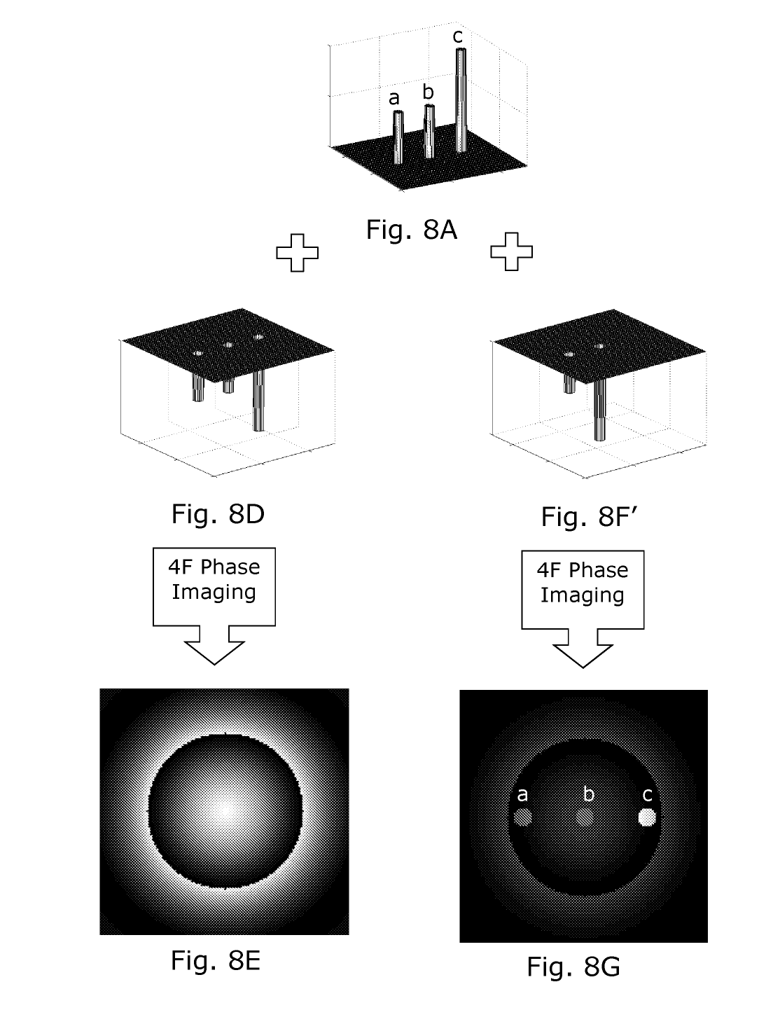

In the following, embodiments and examples illustrating some of the schemes for selecting a synthesized modulation to optimise the out image are described in relation to FIGS. 4-10. In all embodiments, the object modulation is selected to represent situations that may occur in typical phase imaging. For purposes of illustration, the object modulations are selected to display the characteristics in a simple or exaggerated way which may not occur in natural objects.

### Improving the Synthetic Reference Wave

As mentioned previously, common-path interferometer uses the low-frequency components of the input phase modulation to create the reference wave for making the phase patterns visible. In a constructed example, a binary 0-pi-checkerboard object phase modulation was imaged. The light from the pi-out-of-phase regions nearly cancelled each other on-axis, resulting in a very weak zero-order beam and synthesized reference wave. The output image shown in FIG. 4A therefore has a very low intensity contrast. A perfectly symmetric phase pattern would not contain any zero-order component but, in this case, the truncation due to the circular aperture created an imbalance between the 0 and pi regions, which left a residual reference wave and a poor contrast output.

In an embodiment of the present invention, an SLM (here diffractive gratings) at the input plane are used to apply a synthesized amplitude modulation onto the object phase modulation to improve contrast in the GPC output (i.e. the selected parameter is contrast). With the GPC system aligned along the proper diffraction order, a merged modulation containing both amplitude and phase modulations will be input to the GPC.

The selected synthesized amplitude modulation is determined based on a threshold function of the low contrast GPC output image shown in FIG. 4A. Thresholding this image yields a binary checkerboard pattern, which we can use as basis for choosing the diffractive amplitude modulation pattern (the synthesized modulation) at the GPC input plane. Instead of using a 0-1 binary amplitude checkerboard pattern, we used a 0.5-1 input amplitude modulation pattern shown in FIG. 4C so as to illuminate all the areas of the object. Impressing this synthesized amplitude modulation upsets the balance between the 0- and pi-phase regions, which thereby strengthens the SRW and improves the contrast in the output image, see the improved contrast in FIG. 4B and its line scan in FIG. 4D (solid); a line scan through the initial low-contrast image of FIG. 4A (dotted) is included for comparison.

### Phase Quantification

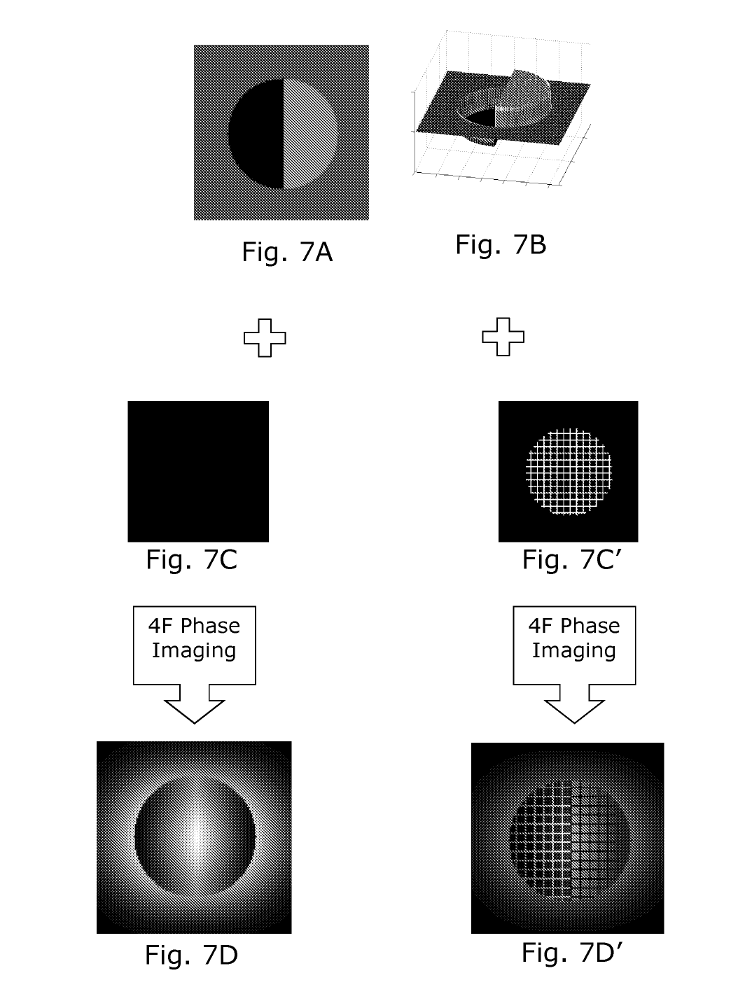

As mentioned previously, it is an issue in interferometric phase imaging that different phases can have the same intensity in the resulting interference pattern. For example, +pi/2 and −pi/2 phase beams have the same intensity when interfering with a 0-phase reference beam. FIG. 5A shows the grayscale representation of an exemplary object phase modulation (white: +pi/2; black: −pi/2). Using this as the GPC input generates the output image shown in FIG. 5B. This output contains ambiguities since regions corresponding to positive and negative phase values both have the same intensity (e.g. see the arrows in FIGS. 5A and 5B).

In an embodiment of the present invention, an SLM (here with diffractive gratings) at the input plane are used to apply a synthesized phase modulation onto the object phase modulation to resolve the phase ambiguity in the GPC output.

The selected synthesized amplitude modulation is determined based on a threshold function of the ambiguous GPC output image shown in FIG. 5B. Thresholding this image yields the pattern in FIG. 5C. The diffractive phase input for GPC (the merged modulation) will correspond to the multiplication of this threshold pattern (the synthesized modulation) with the high-frequency grating (the object modulation). Projecting the phase object onto this diffractive input and then aligning the GPC system along the proper diffraction order creates the output intensity pattern shown in FIG. 5D. Here the positive- and negative-phase regions now appear with different intensity. Hence, the additional phase offset allowed distinguishing between the phase between initially intensity-degenerate regions. This shows that the present invention can be used to introduce further spatial phase modulation onto a phase object to resolve phase ambiguities in the GPC output.

### Phase Range Adjustment

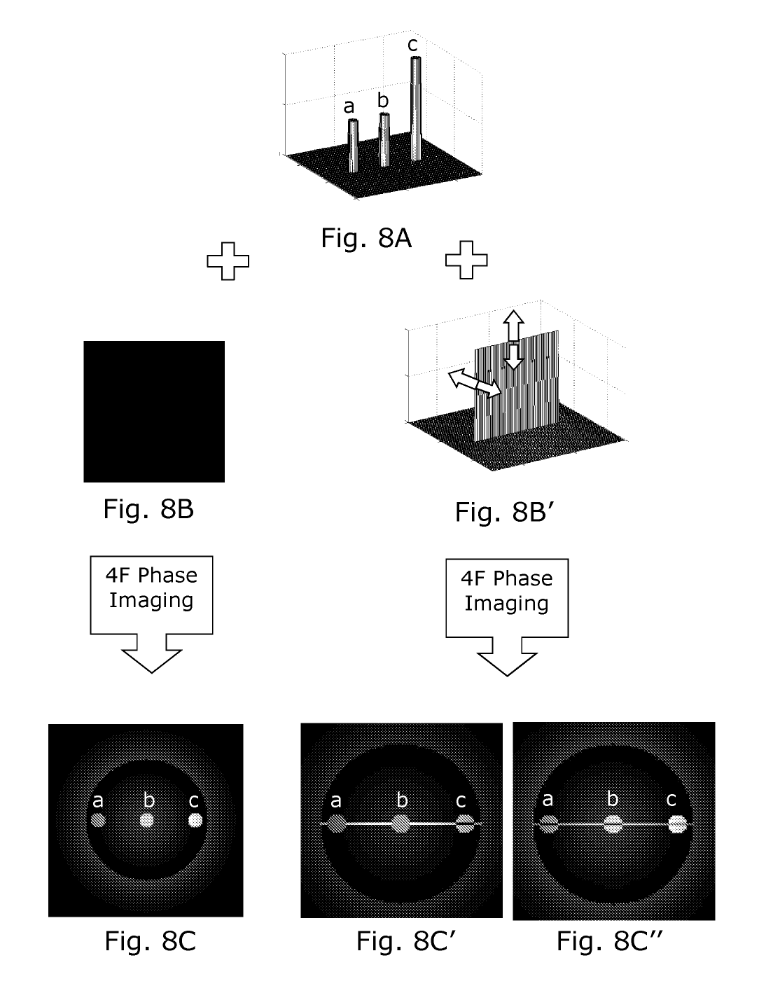

FIGS. 6A and 6B illustrates top and perspective views of the object phase modulation. FIG. 6C shows the synthesized phase modulation, which is initially zero or flat, the “+” indicates that the object modulation and the synthesized modulation superimposes to form the merged modulation. FIG. 6D shows the resulting output image when the merged modulation is imaged in a 4F phase imaging system.

The object modulation of FIGS. 6A and B is selected as a function with a very large phase range. The output image in FIG. 6D is the result with no added synthesized modulation. The central peak of the object phase modulation is outside the operating phase range of the used 4F phase imaging system, and therefore becomes darker instead of brighter.

As described previously, the phase range can be adjusted or “compressed” to form a merged modulation with a narrower phase range by adding a synthesized modulation that only partially cancels the object phase modulation. A synthesized modulation doing this is shown in FIG. 6C′, and the resulting output image shown in FIG. 6D′ clearly mimics the object phase modulation much better. In this case, the synthesized modulation can be derived based on knowledge of the object modulation, or one can go through the process of first cancelling the object modulation completely as described elsewhere, and then scale the cancelling synthesized modulation to be only partially cancelling.

### Pre-Programmed Synthesized Phase Modulation Improving the Output Image

FIGS. 7A and 7B illustrates top and perspective views of the object phase modulation. FIG. 7C shows the synthesized phase modulation, which is initially zero or flat, the “+” indicates that the object modulation and the synthesized modulation superimposes to form the merged modulation. FIG. 7D shows the resulting output image when the merged modulation is imaged in a 4F phase imaging system.

The object modulation of FIGS. 7A and B is selected to include equally abundant opposite phase parts that balance to cancel out and thereby result in a weak synthetic reference wave, which would result in poor contrast in the output image.

The output image in FIG. 7D is the result with no added synthesized modulation. As can be seen, the contrast in the output image is so that the large phase step in the object modulation is not represented.

As described previously, when it is impractical to derive the synthesized modulation from the output image (e.g., due to too low contrast), the synthesized phase modulation can employ default modulations that are not derived from the output image. Such default modulation is shown in FIG. 7C′ here involving a grid, and the resulting output image shown in FIG. 7D′ clearly mimics the object phase modulation much better. These simple default patterns are preferably selected to be easy to deconvolute in software post-processing of the output image, and the improved output image may then be used to form the basis for deriving a subsequent synthesized modulation.

### Bijection/Calibration for Quantitative Phase Imaging

FIG. 8A illustrates a perspective view of the object phase modulation. FIG. 8B shows the synthesized phase modulation, which is initially zero or flat, the “+” indicates that the object modulation and the synthesized modulation superimposes to form the merged modulation. FIG. 8C shows the resulting output image when the merged modulation is imaged in a 4F phase imaging system.

The object modulation of FIG. 8A is selected to include three columns, a, b, and c where a and b have the same phase (e.g. pi/2); and c has higher phase (e.g. pi). In the resulting output image of FIG. 8C with no synthesized modulation, column a appears weaker; and columns b and c appear similar. The difference in appearance between a and b in the output image, despite the two columns having the same phase, is caused by a phase mapping distortion. Such phase mapping distortion may e.g. be due to an artifact of the imaging system or inherent in the optical system used.

Now, a synthesized modulation with a phase line with adjustable phase height and position shown in FIG. 8B′ is selected to calibrate the relation or mapping between input phase values and output intensity values, here in order to create a bijection between input merged phase values and output intensity values.

A −pi/2 phase line in the synthesized modulation in FIG. 8B′, creates a dark stripe through columns a and b, but not through c, in the resulting output image in FIG. 8C′. This confirms that the phase columns a and b are both pi/2 whereas c is different.

A −pi phase line in the synthesized modulation in FIG. 8B′, creates a dark stripe through column c, but not through columns a and b, in the resulting output image in FIG. 8C″. This confirms that the phase of columns c is pi and different from a and b.

Using the column positions from the output images and applying the calibrated/quantitative phase obtained through the synthesized modulations with phase lines, we can create a new, negative synthetic modulation that can cancel the object phase as shown in FIG. 8D. A standard output image for blank input as shown in FIG. 8E confirms total cancellation and verifies that the synthetic modulation is indeed the negative image of the object phase.

Alternately, one can adjust the phases of columns a, b, and c in the synthesized modulation shown in FIG. 8F so that they appear with correct relative brightness in the output image of FIG. 8G. This is similar to range adjustment described above, but this time it corrects inherent phase imaging distortion.

### Applications

The inventors propose applications within imaging of largely transparent biological samples; performing quantitative phase imaging for laboratory measurements and industrial applications.

1. A method for reconstructing a quantitative phase image of an object under examination using a 4F-based optical phase imaging system during operation of the phase imaging system, the method comprising:
evaluating an output image from a 4F-based optical phase imaging system, the output image at least being of a complex spatial object modulation, aₒ(x, y) e^{iφ}^{ₒ}^{(x,y)}, impressed by an object on an input to the phase imaging system;
based on the output image, selecting a complex spatial synthesized modulation, aₛ(x, y) e^{iφ}^{ₛ}^{(x,y)}, adapted to optimize a selected parameter in the output image;
addressing a two-dimensional, complex spatial light modulator to impress the synthesized modulation, the spatial light modulator being arranged so that the synthesized modulation is superimposed with the object modulation to form a merged modulation, a_{M}(x, y) e^{iφ}^{_{M}}^{(x,y)}=aₒ(x,y)·aₛ(x, y) e^{iφ}^{ₒ}^{(x,y)+φ}^{ₛ}^{(x,y))} impressed on the input to the phase imaging system; and
reconstructing a quantitative phase image of the object based on the synthesized modulation and an output image of the merged modulation, I_{M}(x, y).

2-16. (canceled)

17. The method according to claim 1, wherein the selected parameter in the output image comprises one or more of: resolution, contrast, phase quantification, phase range, a relation or mapping between input phase values and output intensity values, or cancellation of object modulation by synthesized modulation.

18. The method according to claim 1, wherein the selected parameter in the output image comprises contrast and wherein the synthesized modulation is selected to disturb a balance between parts of the object phase modulation that at least partly cancel out and result in a weak synthetic reference wave by introducing an imbalanced synthesized modulation for these parts.

19. The method according to claim 1, wherein the selected parameter in the output image comprises phase quantification and wherein the synthesized modulation is selected to resolve phase ambiguities between parts in the object modulation with equal but opposite phase shifts by introducing a synthesized phase modulation providing a phase-offset for parts having similar intensity values in the output image.

20. The method according to claim 1, wherein the selected parameter in the output image comprises a relation between input phase values and output intensity values and wherein the synthesized modulation is selected to calibrate this relation.

21. The method according to claim 1, wherein the selected parameter in the output image comprises a relation between input phase values and output intensity values and wherein the synthesized modulation is selected to form a bijection between input phase values and output intensity values.

22. The method according to claim 1, wherein the selected parameter in the output image comprises resolution and wherein the synthesized modulation is selected to project phase fringes to redirect light from fine features having spatial frequencies that would otherwise deflect light beyond the acceptance angle of the phase imaging system, but are instead redirected towards the phase imaging system due to the additional synthesized modulation.

23. The method according to claim 1, wherein the selected parameter in the output image comprises cancellation of object modulation by synthesized modulation and wherein the synthesized modulation is selected to, based on the output image of the object or merged modulation and a known or anticipated relation between input phase modulation and output intensity values, cancel the object phase modulation.

24. The method according to claim 23, wherein the selection of the synthesized modulation is also based on knowledge of the output image of the phase imaging system without object modulation and synthesized modulation.

25. The method according to claim 1, wherein the selected parameter comprises phase range and wherein the synthesized modulation is selected to only partially cancelling the object phase modulation to form a merged modulation having a smaller phase range than the object modulation.

26. The method according to claim 1, wherein selecting the synthesized modulation comprises selecting a synthesized modulation derived from or being proportional to a threshold function of the output image of the object modulation.

27. The method according to claim 1, wherein selecting the synthesized modulation comprises iteratively performing the evaluation of the output image, the selection of the synthesized modulation, and the addressing of the spatial light modulator to impress the synthesized modulation before reconstructing the quantitative phase image of the object.

28. The method according to claim 1, wherein selecting the synthesized modulation comprises defining setting the synthesized amplitude modulation to define regions of interest in the object by encoding additional phase modulation outside the regions of interest.

29. The method according to claim 1, wherein the 4F-based optical phase imaging system is or is comprised by a microscope, or is in optical communication with an optical path of a microscope.

30. A computer program product for reconstructing a quantitative phase image of an object imaged by a 4F-based optical phase imaging system, the computer program being configured to perform the method of claim 1 when executed by an electronic processor connected to the complex spatial light modulator and to an image detector arranged at an output plane of the phase imaging system.

31. A 4F-based optical phase imaging system for reconstructing a quantitative phase image of an object, the phase imaging system comprising:
a 4F setup and a light source;
an object holder arranged to so that an object held by the holder is illuminated by the light source to impress an object modulation on light input to the 4F setup;
an addressable, two-dimensional, complex spatial light modulator arranged so that a synthesized modulation impressed by the spatial light modulator will superimpose with an object modulation impressed by an object held by the object holder;
an image detector arranged at an output plane of the 4F setup;
an electronic processor connected to the complex spatial light modulator and to the image detector; and
a memory holding a computer program product configured to perform the method of claim 1, when executed by the electronic processor.
